(19) United States
(12) Patent Application Publication
(10) Pub. No.: US 2014/0065481 A1
(43) Pub. Date: Mar. 6, 2014

(54) Positive-Electrode Active Material, Manufacturing Method Of The Same, And Nonaqueous Electrolyte Rechargeable Battery Having The Same

(71) Applicants: Tokyo Metropolitan University, Tokyo (JP); Denso Corporation, Kariya-city (JP)

(72) Inventors: Shuhei Yoshida, Tokoname-city (JP); Daisuke Shibata, Tokai-city (JP); Kiyoshi Kanamura, Hachioji-city (JP)

(73) Assignees: Tokyo Metropolitan University, Tokyo (JP); DENSO CORPORATION, Kariya-city (JP)

(21) Appl. No.: 14/012,253

(22) Filed: Aug. 28, 2013

(30) Foreign Application Priority Data
Aug. 29, 2012 (JP) 2012-188881

(51) Int. Cl. H01M 4/36; H01M 4/22

(52) U.S. Cl. CPC H01M 4/366; H01M 4/22
USPC 429/220; 429/231.8; 429/224; 429/223; 429/221; 264/618

(57) ABSTRACT

A positive-electrode active material for a non-aqueous electrolyte rechargeable battery includes a core portion and a shell portion. The core portion contains an inorganic oxide with a polyanionic structure. The shell portion coats the core portion. The shell portion contains a carbon and an inorganic accelerator that accelerates generation of the shell portion by the carbon. The content of the inorganic accelerator is 0.2 mass % or more of the inorganic oxide when the mass of the inorganic oxide is defined as 100%.

### CROSS-REFERENCE TO RELATED APPLICATION

This application is based on Japanese Patent Application No. 2012-188881 filed on Aug. 29, 2012, the disclosure of which is incorporated herein by reference.

### TECHNICAL FIELD

The present disclosure relates to a positive-electrode active material for a non-aqueous electrolyte rechargeable (secondary) battery, a method of manufacturing the positive-electrode active material, and a non-aqueous electrolyte rechargeable battery having the positive-electrode active material.

### BACKGROUND

Conventionally, lithium-ion rechargeable batteries, which are characterized by a high energy density, have been used for commercial small instruments, such as a cellular phone and a notebook personal computer. Recently, it has been considered to use the lithium ion rechargeable batteries to large devices, such as a fixed electrically storage system, a hybrid vehicle, and an electric vehicle. To use the lithium ion rechargeable batteries to such large devices, it is required to increase the capacity of the lithium ion rechargeable batteries.

The capacity of the lithium ion rechargeable battery greatly relies on the type of a positive-electrode active material that electrochemically inserts and extracts lithium ion. As the positive-electrode active material, powder of an inorganic oxide, such as LiCoO₂, LiMn₂O₄, or LiFePO₄, is used.

In fact, the capacity, a battery voltage, input-output characteristics, and safety are different depending on the types of positive-electrode active material. Therefore, the positive-electrode active material is used differently depending on the use of the battery. It has been known that a polyanionic positive-electrode active material containing XO₄ tetrahedrons, in which X is P, As, Si, Mo, and the like, in its crystal structure is stable.

Among polyanionic positive-electrode active materials, olivine-type positive electrodes (LiMPO₄), such as LiFePO₄ and LiMnPO₄, are excellent in thermal stability. Patent Literature 1 teaches to use LiFePO₄ and LiMnPO₄ in the lithium ion rechargeable battery. However, since the XO₄ tetrahedrons of the polyanionic positive-electrode active material are stable, Li diffusion rate and electronic conductivity of the polyanionic positive-electrode active material are low.

To address such issue, Patent Literatures 2 and 3 teach to make the positive-electrode active material fine particle and to form a carbon-coating on a surface of the active material.

LiFePO₄ of the olivine-type positive electrode has low electric potential, as compared with LiCoO₂, LiNiO₂, and the like. Therefore, it is difficult to use LiFePO₄ in xEV, such as EV, HEV, or PEV, which requires a high energy density.

LiMnPO₄, which has the same olivine structure as LiFePO₄, has a lithium intercalation electric potential of 4.0 V (Li/Li⁺), which is higher than 3.4 V (Li/Li⁺) of LiFePO₄. Therefore, there is a possibility that LiMnPO₄ achieves the high energy density.

Since the LiMnPO₄ has the high potential, hopping of a valance electron of a transition metal (e.g., Mn) is blocked. Therefore, the electronic conductivity of the LiMnPO₄ is lower than that of LiFePO₄.

To address the decrease of the electronic conductivity of LiMnPO₄, methods of forming a carbon-coating on the surface of the LiMnPO₄ (i.e., forming a core-shell structure), similar to the case of LiFePO₄, have been variously studied. For example, Patent Literature 4 discloses a method of forming a carbon-coating after supporting Fe or Ni on the surface of LiMnPO₄.

In the method disclosed in Patent Literature 4, Fe or Ni is supported after LiMnPO₄ is formed. Thereafter, a carbon-coating layer is formed. That is, it is necessary to separately employ a step of supporting Fe or Ni, resulting in an increase in manufacturing cost.

### PATENT LITERATURES

[Patent Literature 1] U.S. Pat. No. 5,910,382 A
[Patent Literature 2] U.S. Pat. No. 6,962,666 B2
[Patent Literature 3] U.S. Pat. No. 7,457,018 B2
[Patent Literature 4] JP 2010-135305 A

### SUMMARY

The present disclosure has been made in view of the foregoing matter, and it is an object of the present disclosure to provide a positive-electrode active material for a non-aqueous electrolyte rechargeable battery, which has a polyanionic core-shell structure having excellent electronic conductivity, and a manufacturing method for the positive-electrode active material, and a non-aqueous electrolyte rechargeable battery having the positive-electrode active material.

The inventors examined about the decrease in electronic conductivity. As a result, the inventors found that nuclear growth of LiMnPO₄ is easily carried our and a particle diameter thereof becomes large since LiMnPO₄ has a structure more stable than that of LiFePO₄. Also, the inventors found that a carbonization reaction (carbonization reduction reaction of a carbon source) is less likely promoted on the surface of LiMnPO₄ surface, since the structure of LiMnPO₄ is stable.

That is, the inventors assured that the reduction of the electronic conductivity of LiMnPO₄ is caused by the increase in particle diameter (primary particle) and unevenness of the carbon coating (i.e., there are portions where the carbon coating is formed and where the carbon coating is not formed), in addition to that the hopping of the Mn valance electron is not easily carried out. The inventors found that the foregoing matter can be solved by a fine positive-electrode active material having a uniform carbon coating.

According to an aspect of the present disclosure, a positive-electrode active material for a non-aqueous electrolyte rechargeable battery has a core-shell structure including a core portion and a shell portion. The core portion includes an inorganic oxide with a polyanionic structure. The shell portion covers the core portion. The shell portion contains a carbon and an inorganic accelerator that accelerates generation of the shell portion by the carbon. The content of the inorganic accelerator is 0.2 mass % or more of the mass of the inorganic oxide, when the mass of the inorganic oxide is defined as 100%.

In the above positive-electrode active material, the shell portion contains the inorganic accelerator that accelerates generation of the shell portion by the carbon. That is, when the shell portion is generated, the inorganic accelerator is disposed at a position where the shell portion is to be generated, that is, on a periphery of the inorganic oxide that forms the core portion. Since the inorganic accelerator is disposed on the periphery of the inorganic oxide, generation of the shell portion by the carbon is accelerated, and thus a carbon coating is evenly formed on the surface of the core portion as the shell portion. Since the generation of the shell portion is accelerated by the inorganic accelerator, grain growth of the core portion made of the inorganic oxide can be reduced.

When the mass of the inorganic oxide is defined as 100%, the content of the inorganic accelerator is 0.2 mass % or more. In this case, the effect of the inorganic accelerator is realized, that is, the effect of generation of the shell portion is realized.

According to an aspect of the present disclosure, in a method of manufacturing a positive-electrode active material for a non-aqueous electrolyte rechargeable battery, a mixed solution is prepared by adding an inorganic raw material for generating an inorganic oxide having a polyanionic structure to an aqueous solvent. A pH of the mixed solution is adjusted. The mixed solution the pH of which has been adjusted is heated in a pressuring condition. An inorganic oxide generated by the heating is sintered under an inert atmosphere and in a state where the inorganic oxide is mixed with an anionic aromatic compound as a carbon raw material for forming a shell portion and an inorganic accelerator for accelerating generation of the shell portion from the carbon raw material.

A positive-electrode active material manufactured by the method described above has a core-shell structure in which the core portion includes the inorganic oxide with the polyanionic structure, and the shell portion forms the carbon coating on the core portion.

In the positive-electrode active material described above and the positive-electrode active material manufactured by the above-described method, the generation of the shell portion is enhanced by the inorganic accelerator, the core portion is entirely coated with the shell portion. Therefore, it is less likely that an oxide will be formed on the surface of the inorganic (compound) oxide of the core portion. Namely, disadvantages caused by the oxide formed on the surface of the inorganic (compound) oxide of the core portion can be reduced.

Since the generation of the shell portion is enhanced by the inorganic accelerator, the shell portion can be formed in a state where the grain growth of the core portion is restricted. Therefore, the decrease of the electronic conductivity is reduced.

The positive-electrode active material described above is used in a non-aqueous electrolyte rechargeable battery. In the non-aqueous electrolyte rechargeable battery using the positive-electrode active material described above, since the oxide will not be formed on the surface of the inorganic (compound) oxide of the core portion, electric resistance due to the oxide can be reduced. Therefore, a battery capacity improves.

### BRIEF DESCRIPTION OF THE DRAWINGS

The above and other objects, features and advantages of the present disclosure will become more apparent from the following detailed description made with reference to the accompanying drawings, in which:

FIG. 1 is a diagram illustrating a cross-sectional view of a coin-type battery as an example of a non-aqueous electrolyte rechargeable battery according to an embodiment of the present disclosure;

FIG. 2 is a diagram illustrating positive-electrode active materials as examples 1 to 6 and comparative examples 1 to 6 and characteristic thereof; and

FIG. 3 is a diagram illustrating an example of a process of manufacturing a positive-electrode active material according to an embodiment of the present disclosure.

### DETAILED DESCRIPTION

(Positive-Electrode Active Material for Non-Aqueous Electrolyte Rechargeable Battery)

In an embodiment, a positive-electrode active material for a non-aqueous electrolyte rechargeable battery has a core-shell structure including a core portion and a shell portion. The core portion includes an inorganic oxide with a polyanionic structure. The shell portion covers the core portion.

The shell portion contains a carbon and an inorganic accelerator that accelerates the carbon to form the shell portion. The content of the inorganic accelerator is 0.2 mass % or more when the mass of the inorganic oxide is defined as 100%.

In an embodiment of the positive-electrode active material for a non-aqueous electrolyte rechargeable battery, the inorganic oxide with the polyanionic structure, which forms the core portion, is not limited to a specific one. That is, the inorganic (compound) oxide provides an effect in a positive electrode active material with a structure including XO₄, which has a stable crystal structure, and in a positive electrode active material with a structure including X₂O₇.

In an embodiment of the positive-electrode active material for a on-aqueous electrolyte-rechargeable battery, the inorganic oxide is LiₓMn_{y}M_{1-y}O₄, in which M is one or more selected from Co, Ni, Fe, Cu, Cr, Mg, Ca, Zn, and Ti, X is one or more selected from P, As, Si, and Mo, x satisfies 0≦x<2.0, and y satisfies 0.7≦y≦1.0.

When the core portion made of the inorganic oxide having a polyanionic structure expressed by the above chemical formula is used in the positive-electrode active material for the non-aqueous electrolyte rechargeable battery, an influence of an oxide on a surface of the inorganic oxide is reduced, and thus the decrease in battery characteristic of the non-aqueous electrolyte rechargeable battery is reduced.

In an embodiment of the positive-electrode active material for a non-aqueous electrolyte rechargeable battery, examples of the inorganic (compound) oxide is LiNiPO₄-based oxide, LiCoPO₄-based oxide, Li₂MnP₂O₇-based oxide, Li₂MnSiO₄-based oxide and the like.

In an embodiment of the positive-electrode active material for a non-aqueous electrolyte rechargeable battery, a diameter of a primary particle diameter is 600 nm or less, and a maximum pore is 15 Å (1.5 nm) or less. When the positive-electrode active material satisfies these conditions, the conductivity of the positive-electrode active material improves.

The conductivity of the positive-electrode active material more improves as the primary particle diameter of the positive-electrode active material reduces. The conductivity of the positive-electrode active material (inorganic oxide) itself is not high. As the primary particle diameter increases, the rate of positive-electrode active material (inorganic oxide) that does not contribute to the conductivity increases. When the primary particle diameter is 600 nm or less, the conductivity of the positive-electrode active material improves.

In a positive-electrode active material having the core-shell structure, there are two types of pore, one being fine pores defined in the carbon forming the shell portion and the other being coarse pores provided without forming the shell portion. The coarse pores have a pore diameter greater than that of the fine pores. The coarse pores are provided as the shell portion is not formed, that is, provided by portions where the shell portion is not formed. Therefore, the core portion is exposed through the coarse pores. That is, when the coarse pores are formed, the surface of the inorganic oxide of the core portion is exposed, and an oxide is formed.

In an embodiment of the positive-electrode active material for a non-aqueous electrolyte rechargeable battery, as the maximum pore, which is calculated by measuring the pores, is reduced, the coarse pores are reduced. With this, formation of the oxide is reduced. When the maximum pore is 15 Å or less, the formation of the oxide is reduced, and the conductivity of the positive-electrode active material improves.

(Manufacturing Method of Positive-Electrode Active Material for Non-Aqueous Electrolyte Rechargeable Battery)

A manufacturing method of a positive-electrode active material, which has a core-shell structure including a core portion that contains an inorganic oxide with a polyanionic structure and a shell portion that contains a carbon coating the core portion, includes a mixed solution preparation step, a mixed solution pH adjustment step, a mixed solution heating step, and a mixed solution sintering step.

In the mixed solution preparation step, a mixed solution is prepared by adding an inorganic raw material for generating an inorganic oxide with a polyanionic structure to an aqueous solvent. In the mixed solution pH adjustment step, pH of the mixed solution is adjusted. In the heating step, the mixed solution the pH of whish has been adjusted is heated under a pressuring condition. In the mixed solution sintering step, the inorganic oxide generated by the heating is sintered under an inert atmosphere.

The inorganic oxide is sintered in a state where the inorganic oxide is mixed with an anionic aromatic compound as a carbon raw material for forming the shell portion and an inorganic accelerator for accelerating generation of the shell portion from the carbon raw material.

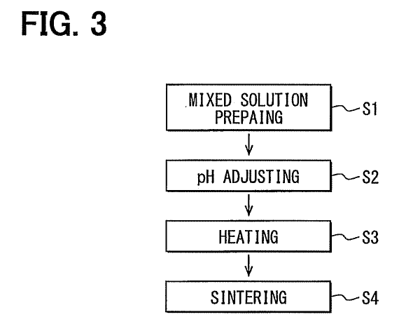

In the manufacturing method, firstly, the mixed solution preparation step is performed (e.g., S1 in FIG. 3). In the mixed solution preparation step, the mixed solution is prepared by adding the inorganic raw material for generating the inorganic oxide with the polyanionic structure to the aqueous solvent. Hereinafter, the mixed solution preparation step will be also referred to as the raw material mixed solution preparation step. The raw material mixed solution of the inorganic oxide is prepared in the raw material mixed solution preparation step. When the raw material mixed solution is treated by a subsequent process, the inorganic oxide with the polyanionic structure is generated.

After the raw material mixed solution preparation step, the mixed solution pH adjustment step is performed (e.g., S2 in FIG. 3). Since the pH of the mixed solution is adjusted, the inorganic oxide is generated in the subsequent process. Also, since the pH of the mixed solution is adjusted in the mixed solution pH adjustment step, the pH of the mixed solution is controlled and the generation of the inorganic oxide is controlled in the subsequent process of generating the inorganic oxide. That is, the adjustment of the pH of the mixed solution in the mixed solution pH adjustment step restricts the inorganic oxide from being formed coarse.

Further, the mixed solution heating step is performed (e.g., S3 in FIG. 3). In the mixed solution heating step, the mixed solution the pH of which has been adjusted is heated under a pressuring condition. Since the mixed solution is heated under the pressuring condition, the inorganic oxide is generated.

Thereafter, the sintering step is performed (e.g., S4 in FIG. 3). In the sintering step, the inorganic oxide generated by the heating step is sintered under the inert atmosphere. Since the inorganic oxide is sintered under the inert atmosphere, the shell portion is formed from a precursor of the shell portion disposed on a periphery of the inorganic oxide.

The inorganic oxide is sintered in a state where the inorganic oxide is mixed with the anionic aromatic compound as the carbon raw material for forming the shell portion and the inorganic accelerator for accelerating generation of the shell portion from the carbon raw material. That is, when the inorganic oxide is sintered, the carbon raw material for generating the shell portion and the inorganic accelerator are disposed on a periphery of the inorganic oxide.

Since the inorganic oxide is sintered in the state where the carbon raw material and the inorganic accelerator are disposed, the shell portion made of carbon containing the inorganic accelerator is formed on the surface of the inorganic oxide.

In the manufacturing method, the anionic aromatic compound as the raw material of the shell portion and the inorganic accelerator can be added to the mixed solution (or the inorganic oxide) in any step, as long as the anionic aromatic compound and the inorganic accelerator are disposed on the periphery of the inorganic oxide when the sintering step is performed. That is, the anionic aromatic compound and the inorganic accelerator may be added to the mixed solution or the inorganic oxide at any timing, such as in the material mixed solution preparation step, in the mixed solution pH adjustment step; at a timing between the heating step and the sintering step. The anionic aromatic compound and the inorganic accelerator may be added at the same time or at different times.

That is, each of the anionic aromatic compound and the inorganic accelerator may be added to at least one of the mixed solution and the inorganic oxide generated.

As the carbon raw material for forming the shell portion, the anionic aromatic compound is used. The anionic aromatic compound creates binding in the inorganic oxide by an aromatic electrophilic substitution reaction. As a result, the anionic aromatic compound is disposed on the periphery of the inorganic oxide.

The anionic aromatic compound is not limited to a specific one as long as the anionic aromatic compound serves as the carbon raw material for forming the shell portion, that is, as long as the anionic aromatic compound is disposed on the periphery of the inorganic oxide in the sintering. Preferably, the anionic aromatic compound is a compound that causes an aromatic electrophilic substitution reaction.

The anionic aromatic compound is expressed as CₙH₂ₙ₊₁-A-P-Ma, and the dosage of the anionic aromatic compound is preferably 10 mass % or less of the mass of the core portion. In the expression of CₙH₂ₙ₊₁-A-P-Ma, A is an aromatic hydrocarbon, P is one or more selected from carboxylic acid, sulfonic acid, and phosphate ester, and Ma is an alkali metal element.

When the anionic aromatic compound is a compound expressed by the above chemical formula of CₙH₂ₙ₊₁-A-P-Ma, the anionic aromatic compound is disposed on the periphery of the inorganic oxide by the aromatic electrophilic substitution reaction.

A structure of the anionic aromatic compound is not limited to a specific one as long as the anionic aromatic compound is a compound expressed as CₙH₂ₙ₊₁-A-P-Ma, in which A is an aromatic hydrocarbon, P is one or more selected from carboxylic acid, sulfonic acid, and phosphate ester, and Ma is an alkali metal element. Examples of the aromatic hydrocarbon A are a naphthalene group, a fluorene group, an azulene group, an acenaphthylene group, a biphenylene group, a pyrene group, a tetracene group, and a benzanthracene group.

When the dosage of the anionic aromatic compound is 10 mass % or less of the mass of the core portion, the anionic aromatic compound is disposed on the periphery of the inorganic oxide by the aromatic electrophilic substitution reaction.

The carbon raw material for forming the shell portion may contain a carbon raw material other than the anionic aromatic compound. The carbon raw material other than the anionic aromatic compound may be any material that is used as a carbon raw material for forming a shell portion in a conventional core-shell structure. For example, the carbon raw material may be an organic compound such as sucrose, carboxylmethyl cellulose (CMC), polyethylene oxide (PEO), ascorbic acid, citric acid, malic acid, lactic acid, succinic acid, fumaric acid, and maleic acid.

The pH of the mixed solution is preferably adjusted to a range from 3 to 5. When the pH of the mixed solution is adjusted to such a low, range, a generation speed of the inorganic compound is controlled, such as retarded. That is, when the pH of the mixed solution is adjusted to the range from 3 to 5, it is less likely that the inorganic oxide will be coarse. When the pH of the mixed solution is greater than 5, the pH is high and the inorganic oxide becomes coarse. When the pH of the mixed solution is lower than 3, the pH is too low and it is difficult to generate the inorganic oxide.

A step of crushing the sintered body is preferably performed after the sintering step. When the crushing step is performed, secondary particles of the positive-electrode active material adhered during the sintering can be crushed. That is, the positive-electrode active material particle made of fine primary particle can be obtained.

The inorganic oxide is preferably expressed by LiₓMn_{y}M_{1-y}XO₄, in which M is one or more selected from Co, Ni, Fe, Cu, Cr, Mg Ca, Zn, and Ti, X is one or more selected from P, As, Si, and Mo, x satisfies 0≦x<2.0 and y satisfies 0.7≦y≦1.0.

When the core portion made of the inorganic oxide with the polyanionic structure expressed by the above chemical formula is used to the positive-electrode active material for the non-aqueous electrolyte rechargeable battery, the influence of the surface oxide on the inorganic oxide is reduced, and the decrease of the battery characteristic of the non-aqueous electrolyte rechargeable battery is restricted.

Examples of the inorganic (compound) oxide of the positive-electrode active material are LiMnPO₄, LiNiPO₄, LiCoPO₄, Li₂MnP₂O₇, and Li₂MnSiO₄.

In the sintering step of the manufacturing method, a sintering temperature is not limited to a specific temperature as long as the shell portion can be made of carbon, that is, the formation of the shell portion is promoted by the inorganic accelerator.

An inert gas for providing the atmosphere of the sintering step is not limited to a specific one as long as the inert gas does not react with a crushed substance, that is, with inorganic (compound) oxide particle. Examples of the inert gas are argon, helium, and nitrogen. A sintering time of the sintering step is not limited to a specific time as long as the shell portion can be formed from the carbon.

(Non-Aqueous Electrolyte Rechargeable Battery)

A non-aqueous electrolyte rechargeable battery is provided by using a positive-electrode active material described above or produced by the method described above.

The non-aqueous electrolyte rechargeable battery is not limited to a specific one, but is provided at least by using the positive-electrode active material described above or produced by the method described above. The non-aqueous electrolyte rechargeable battery is preferably a lithium ion rechargeable battery.

The non-aqueous electrolyte rechargeable battery may have a similar structure to a conventional non-aqueous electrolyte rechargeable battery, except that the positive-electrode active material described above or produced by the method described above is used at least. The non-aqueous electrolyte rechargeable battery may include a positive electrode, a negative electrode, an electrolytic solution, and any other necessary member.

The positive electrode is formed in a following manner.

The positive-electrode active material described above, a binder, a conductivity assistant and the like are mixed in a solvent such as water or NMP. Then, the mixture is applied on a collector made of a metal such as aluminum.

The binder is preferably made of a polymeric material. The binder is made of a material that is chemically and physically stable in an atmosphere of the rechargeable battery.

Examples of the binder are polyvinylidene fluoride, polytetrafluoroethylene, EPDM, SBR, NBR, and fluororubber. Examples of the conductivity assistant are ketjen black, acetylene black, carbon black, graphite, carbon nanotube, and amorphous carbon. As further examples, the conductivity assistant may be conductive polymer polyaniline, polypyrrole, polythiophene, polyacethylene, polyacene, or the like.

A metal oxide, such as a lithium containing transition metal oxide, can be added to the positive-electrode active material. Examples of the metal oxide are LiCoO₂, LiNiO₂, and LiMn₂O₄.

A negative-electrode active material can be provided by one of or combination of compounds that occlude and discharge lithium ion. Examples of the compound that can occlude and discharge the lithium ion are a metal material, such as lithium, an alloy material containing silicon, tin, and the like, a carbon material, such as graphite, coke, an organic high polymer compound sintered substance, and amorphous carbon. These active materials may be used solely or in any combination.

For example, a lithium metal foil is used as the negative-electrode active material. In this case, the negative electrode may be formed by bonding the lithium metal foil on a surface of a collector made of a metal such as copper. For example, an alloy material or a carbon material is used as the negative-electrode active material. In this case, the negative electrode is formed in a following manner. A negative-electrode active material, a binder, a conductivity assistant and the like are mixed in a solvent such as water or NMP. Then, the mixture is applied on a surface of a collector made of a metal such as copper.

The binder is preferably made of a polymeric material. The binder is preferably a material that is chemically and physically stable in the atmosphere of the rechargeable battery.

Examples of the binder are polyvinylidene fluoride (PVDF), polytetrafluoroethylene (PTFE), ethylene-propylene-diene copolymer (EPDM), styrene butadiene rubber (SBR), acrylonitrile-butadiene rubber (NBR), and fluororubber. Examples of the conductivity assistant are ketjen black, acetylene black, carbon black, graphite, carbon nanotube, and amorphous carbon. As further examples, the conductivity assistant may be provided by conductive polymer polyaniline, polypyrrole, polythiophene, polyacethylene, polyacene, or the like.

An electrolyte is a medium that conveys charge carriers, such as ion between the positive electrode and the negative electrode. The electrolyte is not limited to a specific one, but is preferably an electrolyte that is physically, chemically and electrically stable in the atmosphere where the non-aqueous electrolyte rechargeable battery is used.

The electrolyte is preferably an electrolyte solution provided by solving a supporting electrolyte in an organic solvent. The supporting electrolyte may be one or more selected from LiBF₄, LiPF₆, LiCF₃SO₃, LiN(CF₃SO₂)₂, LiN(C₂F₅SO₂)₂, and LiN(CF₃SO₂)(C₄F₉SO₂).

The organic solvent may be one of or any combination of propylene carbonate (PC), ethylene carbonate (EC), 1,2-dimethoxyethane (DME), dimethyl carbonate (DMC), diethyl carbonate (DEC), ethylmethyl carbonate (EMC), tetrahydrofuran (THF), 2-methyltetrahydrofuran, tetrahydropyran, and the like. In particular, the electrolyte solution containing a carbonate-based solvent has excellent stability in high temperature, and is preferable. Also, a solid polymeric electrolyte containing the above electrolyte in a solid polymer, such as polyethylene oxide, may be used. Further, another solid electrolyte, such as a ceramic having a lithium ion conductivity and a glass, may be used.

A separator is preferably disposed between the positive electrode and the negative electrode to provide electric insulation and ion conductivity between the positive electrode and the negative electrode. In a case where the electrolyte is in a liquid state, the separator serves to hold the liquid electrolyte. Examples of the separator are a porous synthetic resin film, in particular, a polyolefine-based macromolecule, such as polyethylene or polypropylene, a porous membrane made of glass fiber, and nonwoven fabric. It is preferable to employ a separator with a size greater than the positive electrode and the negative electrode so as to provide electric insulation between the positive electrode and the negative electrode.

The positive electrode, the negative electrode, the electrolyte, and the separator are generally housed in a case. The case is not limited to a specific one. The case may be made of a known material, and may have a known shape. That is, the shape of the non-aqueous electrolyte rechargeable battery is not limited to a specific shape, and the non-aqueous electrolyte rechargeable battery of the present disclosure may have any shape, such as a coin shape, a cylindrical shape, or a square shape.

Also, the shape and the material of the case of the non-aqueous electrolyte rechargeable battery are not limited to specific shape and material. The case may be made of a metal or a resin. The case may be a soft case, such as a laminated package, that can maintain its outer shape.

### EXAMPLES

Hereinafter, the present disclosure will be described more in detail with reference to examples in which the present disclosure is employed as a lithium ion rechargeable battery.

### Example 1

Raw material solutions were prepared in a following manner.

1.35 mol of Li₂SO₄, and 0.09 mol of (NH₄)₂HPO₄ were weighted. Also MnSO₄.5H₂O and FeSO₄.7H₂O were weighted such that Mn and Fe are 0.09 mol in total. Each of the raw materials weighted was mixed to a ultrapure water. In this way, the raw material solutions were prepared.

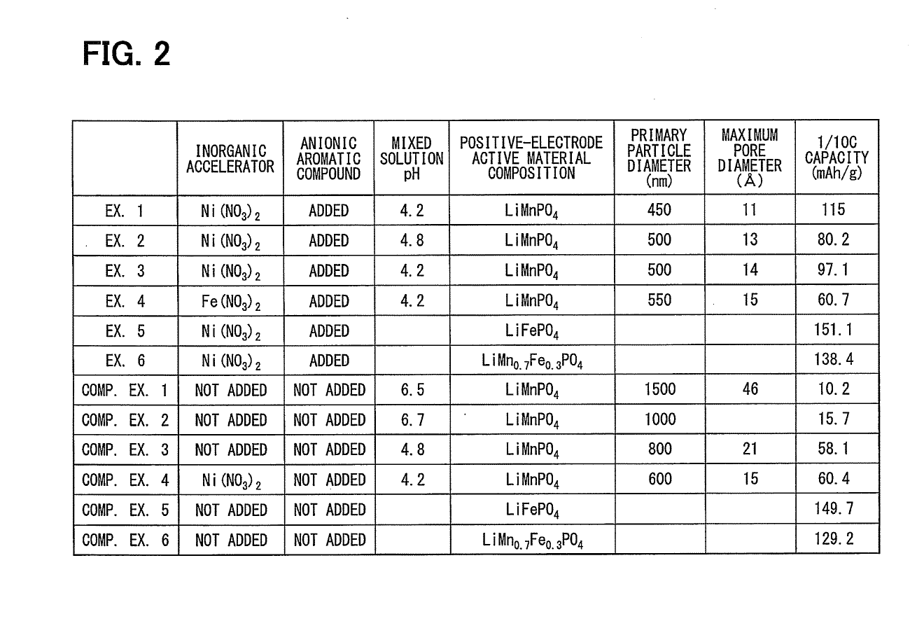

Next, raw material solutions were selected to have a composition shown in a diagram of FIG. 2, and put in a heat-resistant container (capacity: 100 cm³). The raw material solutions were added in an order of Li solution, P solution, Mn solution and Fe solution. After these raw material solutions were added, a CMC aqueous solution was added to the mixed solution such that a solid content becomes 0.86%.

Further, sodium alkylnaphthalene sulfonate as an anionic aromatic compound was added such that the content of the sodium alkylnaphthalene sulfonate is 2 mass % of the mass of an inorganic oxide to be generated. Also, Ni(NO₃)₂ as an inorganic accelerator was added such that a rate of Ni element is 2 mass % of the mass of the inorganic oxide to be generated.

The mixed solution was agitated for 10 minutes at the room temperature under nitrogen gas circulation.

After the agitation, H₃PO₄ was added to adjust a pH of the mixed solution at 4.8.

After the adjustment of pH, the mixed solution was held for 3 hours at 200 degrees Celsius to generate the inorganic oxide by hydrothermal synthesis.

The inorganic oxide generated was powder-washed by centrifugal separation. Then, the inorganic oxide was filtered, and dried for 10 hours at 80 degrees Celsius in a vacuum.

After the drying, the inorganic oxide was heat-treated for 1 hour at 700 degrees Celsius under the argon gas atmosphere containing 3% of hydrogen gas. As a result, an inorganic oxide with a core-shell structure was generated.

The inorganic oxide with the core-shell structure was put into a ball mill, and a cracking treatment was performed for 10 minutes at 4000 rpm.

Therefore, a positive-electrode active material (LiMnPO₄) with the core-shell structure was produced.

### Example 2

As an example 2, a positive-electrode active material (LiMnPO₄) with a core-shell structure was produced in a similar manner to the example 1, except that the sodium alkylnaphthalene sulfonate as the anionic aromatic compound was added after the inorganic oxide was generated by hydrothermal synthesis.

In the example 2, the pH of the mixed solution was adjusted at 4.8.

### Example 3

As an example 3, a positive-electrode active material (LiMnPO₄) with a core-shell structure was produced in a similar manner to the example 1, except that the sodium alkylnaphthalene sulfonate as the anionic aromatic compound was added to be 10 mass % of the mass of the inorganic oxide to be generated.

### Example 4

As an example 4, a positive-electrode active material (LiMnPO₄) with a core-shell structure was produced in a similar manner to the example 1, except that Fe(NO₃)₂ was used as the inorganic accelerator, in place of Ni(NO₃)₂.

### Example 5

As an example 5, a positive-electrode active material (LiFePO₄) was produced in a similar manner to the example 1, except that Li solution, P solution, Fe solution ware selected from the raw material solutions.

### Example 6

As an example 6, a positive-electrode active material (LiMn_{0.7}Fe_{0.3}PO₄) with a core-shell structure was produced in a similar manner to the example 1, except that the ratio of MnSO₄.5H₂O and FeSO₄.7H₂O was changed such that a molar ratio of Mn and Fe is 0.7:0.3.

### Comparative Example 1

As a comparative example 1, a positive-electrode active material (LiMnPO₄) was produced in a similar manner to the example 1, except that an anionic aromatic compound, an inorganic accelerator, CMC and H₃PO₄ were not added.

In the comparative example 1, the pH of a mixed solution was 6.5.

### Comparative Example 2

As a comparative example 2, a positive-electrode active material (LiMnPO₄) was produced in a similar manner to the example 1, except that an anionic aromatic compound, an inorganic accelerator, and H₃PO₄ were not added.

In the comparative example 2, the pH of a mixed solution was 6.7.

### Comparative Example 3

As a comparative example 3, a positive-electrode active material (LiMnPO₄) was produced in a similar manner to the example 1, except that an anionic aromatic compound and an inorganic accelerator were not added.

In the comparative example 3, the pH of a mixed solution was 4.8.

### Comparative Example 4

As a comparative example 4, a positive-electrode active material (LiMnPO₄) was produced in a similar manner to the example 1, except that an anionic aromatic compound was not added.

In the comparative example 4, the pH of a mixed solution was 4.2.

### Comparative Example 5

As a comparative example 5, a positive-electrode active material (LiFePO₄) was produced in a similar manner to the example 1, except that Li solution, P solution, Fe solution were selected from the raw material solutions, and CMC, an inorganic accelerator and H₃PO₄ were not added.

### Comparative Example 6

As a comparative example 6, a positive-electrode active material (LiMn_{0.7}Fe_{0.3}PO₄) was produced in a similar manner to the example 5, except that an anionic aromatic compound and an inorganic accelerator were not added.

(Evaluation)

To evaluate the positive-electrode active materials produced, the particle diameter of a primary particle and a maximum pore of the positive-electrode active materials as the examples 1 to 6 and the comparative examples 1 to 6 were measured.

The primary diameter was measured by SEM, and the maximum pore was measured by a BET method. The measurement results are shown in the diagram of FIG. 2.

(Coin-Type Lithium Ion Rechargeable Battery)

To evaluate the positive-electrode active materials, produced as the examples 1 to 6 and the comparative examples 1 to 6, a coin-type lithium ion rechargeable battery was fabricated using each of the positive-electrode active materials, and a battery capacity was measured.

(Fabrication)

To prepare a positive-electrode active material paste, the positive-electrode active material powder produced, acetylene black as an electric conducting agent, and PVDF as a binder were weighted to have a mass ratio of 85:50:10, and mixed in an agate mortar.

The positive-electrode active material paste prepared was applied on a collector 1a and dried in a vacuum. Thus, a positive electrode 1 having 0.18 mg/mm², 2.0 g/cm³ of positive-electrode active material layer 1b on a surface was produced. In this case, the collector 1a is made of an aluminum foil with a thickness of 5 micrometers (μm) and a size of 15 mm².

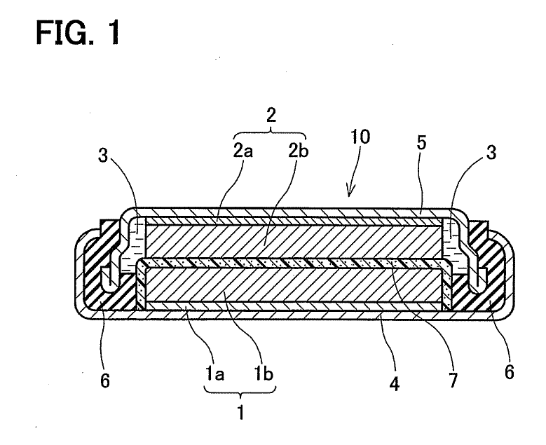

FIG. 1 is a diagram illustrating a cross-sectional view of a coin-type battery 10 produced. As the positive electrode 1, the positive electrode produced above was used. In the negative electrode 2, a lithium metal was used as an active material. The negative electrode 2 includes a negative electrode collector 2a and a negative-electrode active material 2b that is made of the lithium metal and integrated to the surface of the negative electrode collector 2a.

As an electrolyte, a non-aqueous electrolyte solution 3 was used. The non-aqueous electrolyte solution 3 was prepared by adding LiPF₆ to an organic solvent such that the content of the LiPF₆ is 10 mass %. The organic solvent was prepared by mixing EC, DMC and EMC with a volume ratio of 3:3:4. In the non-aqueous electrolyte solution 3, vinylene carbonate (VC) and lithium bis(trifluoromethane sulfonyl)imide (LiTFSI) were added as an additive agent such that the content of VC is 2 mass % and the content of LiTFSI is 0.5 mass %.

The coin-type battery 10 was produced as a coin-type lithium ion rechargeable battery by housing an electric generation element in which a separator 7 is disposed between the positive electrode and the negative electrode in a stainless case together with the above-described non-aqueous electrolyte solution. The separator 7 is a porous membrane made of polyethylene. The case is constructed of a positive-electrode case 4 and a negative-electrode case 5. The positive-electrode case 4 serves as a positive-electrode terminal. The negative-electrode case 5 serves as a negative-electrode terminal. A gasket 6 made of polypropylene was disposed between the positive-electrode case 4 and the negative-electrode case 5 to seal and electrically insulate between the positive-electrode case 4 and the negative-electrode case 5.

An initial charging and discharging was performed to the coin-type battery 10 produced. The initial charging and discharging was performed in a range from 2.0 V to 4.5 V at a ⅓ current rate of a battery capacity (⅓×C), and was repeated for two cycles.

(Evaluation of Coin-Type Battery)

A charging and discharging was performed to the coin-type battery 10 produced. The charging and discharging was performed in a range from 2.0 V to 4.5 V at 1/10 current rate of a battery capacity ( 1/10×C), and the battery capacity at that time was measured. The measured battery capacity of each coin-type battery is shown in the diagram of FIG. 2.

As shown in the diagram of FIG. 2, the diameter of the primary particle of the positive-electrode active material of each of the examples 1 to 6 is smaller than that of each of the comparative examples 1 to 6. Also, the maximum pore of the positive-electrode active material of each of the examples 1 to 6 is smaller than that of each of the comparative examples 1 to 6.

That is, the positive-electrode active material of each of the examples 1 to 6 produced by the above-described method has the smaller primary particle diameter.

Also, the maximum pore of the positive-electrode active material of each of the examples 1 to 6 is small. The positive-electrode active material of each of the examples 1 to 6 has the core-shell structure including the core portion and the shell portion. The positive-electrode active material with the core-shell structure has pores on its surface.

The pores on the surface of the positive-electrode active material includes two-types of pores, one being fine pores defined in the carbon forming the shell portion and the other being coarse pores having a pore diameter greater than that of the fine pores. The coarse pores are provided due to the shell portion being not formed, and thus the core portion is exposed through the coarse pores. That is, when the coarse pores are formed, the surface of the inorganic (compound) oxide of the core portion is exposed, and an oxide is formed.

The positive-electrode active material of each of the examples 1 to 6 has the maximum pore diameter of 15 Å or less. That is, the positive-electrode active material of each of the examples 1 to 6 does not have pores with a large diameter. This substantially means that only the above-described fine pores is measured, and indicates that the core portion is fully coated with the shell portion. When the core portion is fully coated with the shell portion, the surface of the inorganic (compound) oxide of the core portion is not exposed, and thus the oxide is not formed on the surface of the inorganic (compound) oxide of the core portion.

When the example 1 and the comparative examples 1 to 4 are compared, it is appreciated that the positive-electrode active material and the rechargeable battery having excellent battery capacity are obtained by adding the anionic aromatic compound and the inorganic accelerator and by adjusting the pH of the mixed solution.

According to the examples 1 and 2, it is appreciated that the positive-electrode active material and the rechargeable battery achieve the similar effects even when the anionic aromatic compound and the inorganic accelerator are added at different timings.

According to the examples 1 and 3, it is appreciated that the positive-electrode active material and the rechargeable battery having battery capacity higher than the comparative examples are obtained even when the content of the anionic aromatic compound is increased to 10 mass %. In the example 3, it is considered that the battery capacity is lower than that of the example 1 because carbon without forming the shell portion, among carbide of the anionic aromatic compound, is free carbon.

According to the examples 1 and 4, it is appreciated that the positive-electrode active material and the rechargeable battery exert the similar effect irrespective of whether the inorganic accelerator is Ni or Fe.

According to the example 5 and the comparative example 5, the positive-electrode active material and the rechargeable battery having excellent battery capacity are obtained even when the inorganic oxide forming the core portion is provided by LiFePO₄.

According to the example 6 and the comparative example 6, it is appreciated that the positive-electrode active material and the rechargeable battery having excellent battery capacity are obtained when the content rate of Mn is 0.7 or more.

When the example 5 is compared to other examples, it is appreciated that the effect of the positive-electrode active material and the rechargeable battery improve when the Mn containing inorganic oxide is used in the core portion.

As described above, the lithium ion rechargeable battery of each of the examples 1 to 6 has the battery capacity higher than that of each of the comparative examples 1 to 6. Each of the examples 1 to 6 uses the positive-electrode active material that is manufactured by sintering in a state where the anionic aromatic compound and the inorganic accelerator are disposed. That is, the positive-electrode active material manufactured by the method described above achieves the effect of increasing the battery capacity. This effect of the positive-electrode active material is provided when the carbon shell portion is evenly formed on the surface of the core portion, and an oxide is not formed on the core portion.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A positive-electrode active material for a non-aqueous electrolyte rechargeable battery, the positive-electrode active material comprising:
a core portion including an inorganic oxide with a polyanionic structure; and
a shell portion covering the core portion, wherein
the shell portion containing a carbon and an inorganic accelerator that accelerates generation of the shell portion by the carbon, and
a content of the inorganic accelerator is 0.2 mass % or more of the inorganic oxide, when the mass of the inorganic oxide is defined as 100%.

2. The positive-electrode active material according to claim 1, wherein
the inorganic oxide is LiₓMn_{y}M_{1-y}O₄, in which:
M is one or more selected from a group consisting of Co, Ni, Fe, Cu, Cr, Mg, Ca, Zn, and Ti;
X is one or more selected from a group consisting of P, As, Si, and Mo;
x satisfies a relation of 0≦x<2.0; and
y satisfies a relation of 0.7≦y≦1.0.

3. The positive-electrode active material according to claim 1, wherein a primary particle diameter is 600 nm or less, and a maximum pore is 1.5 nm or less.

4. A non-aqueous electrolyte rechargeable battery comprising the positive-electrode active material according to claim 1.

5. A method of manufacturing a positive-electrode active material for a non-aqueous electrolyte rechargeable battery, the positive-electrode active material having a core-shell structure including a core portion and a shell portion, the core portion including an inorganic oxide with a polyanionic structure, the shell portion containing a carbon covering the core portion, the method comprising:
preparing a mixed solution by adding an inorganic raw material for generating the inorganic oxide with the polyanionic structure to an aqueous solvent;
adjusting a pH of the mixed solution;
heating the mixed solution the pH of which has been adjusted in a pressuring condition; and
sintering an inorganic oxide generated by the heating under an inert atmosphere and in a state where the inorganic oxide is mixed with an anionic aromatic compound as a carbon raw material for forming the shell portion and an inorganic accelerator for accelerating generation of the shell portion from the carbon row material.

6. The method according to claim 5, wherein
the anionic aromatic compound is added to at least one of the mixed solution and a precursor of the shell portion, and
the inorganic accelerator is added to at least one of the mixed solution and the precursor of the shell portion.

7. The method according to claim 5, wherein
the anionic aromatic compound is expressed as CₙH₂ₙ₊₁-A-P-Ma, in which:
A is an aromatic hydrocarbon;
P is one or more selected from a group consisting of carboxylic acid, sulfonic acid, and phosphoric ester; and
Ma is an alkali metal element, and
a content of the anionic aromatic compound is 10% or less of the mass of the core portion.

8. The method according to claim 5, wherein the pH of the mixed solution is adjusted to 3 to 5.

9. The method according to claim 5, further comprising crushing a sintered substance generated by the sintering.

10. The method according to claim 5, wherein
the inorganic oxide is LiₓMn_{y}M_{1-y}XO₄, in which:
M is one or more selected from a group consisting of Co, Ni, Fe, Cu, Cr, Mg, Ca, Zn, and Ti;
X is one or more selected from a group consisting of P, As, Si, and Mo;
x satisfies 0≦x<2.0; and
y satisfies 0.7≦y≦1.0.

11. A non-aqueous electrolyte rechargeable battery comprising a positive-electrode active material manufactured by the method according to claim 5.
